(19) United States
(12) Patent Application Publication
(10) Pub. No.: US 2011/0301884 A1
(43) Pub. Date: Dec. 8, 2011

(54) STORAGE TANK MONITORING APPARATUS

(76) Inventors: Carl Denby, Manliva (ES); Kurt Reinhardt, Co. Mayo (IE)

(21) Appl. No.: 13/156,666

(22) Filed: Jun. 9, 2011

Related U.S. Application Data
(63) Continuation of application No. PCT/EP2009/066771, filed on Dec. 9, 2009.

(30) Foreign Application Priority Data
Dec. 9, 2008 (GB) 0822415.6

(51) Int. Cl. G06F 19/00

(52) U.S. Cl. 702/55

(57) ABSTRACT

A storage tank monitoring apparatus includes a measurement device for determining a level of a stored substance within a storage tank. The measurement device is arranged to detect the presence of a second substance in the storage tank. A processor is arranged to generate a signal if the second substance is detected in the storage tank.

This application is a continuation application of International Application No. PCT/EP2009/066771 which was filed on Dec. 9, 2009, the disclosure of which is incorporated herein by reference, and which claims priority from British Patent Application No GB 0822415.6 which was filed on Dec. 9, 2008.

### FIELD OF THE INVENTION

The present invention relates to a storage tank monitoring apparatus and in particular, but not limited to, a storage tank monitoring apparatus for detecting the presence of water in a tank containing a hydrocarbon.

### BACKGROUND OF THE INVENTION

Storage tanks are often used in the UK to store hydrocarbon products such as heating oil, kerosene, diesel and gas oil, and may be situated above ground level, for example to store domestic heating oil or diesel.

A known problem with storage tanks is that they are susceptible to the ingress of water, which may be as a result of rain water entering the storage tank or condensation forming on the inside of the storage tank. Where the storage tank is used, for example, for storing heating oil for a domestic heating system, the presence of water can result in the boiler of the domestic heating system shutting down and may require expert attention to resolve.

There are several methods for checking for the presence of water in a storage tank. One method is to remove the oil filter canister and perform a visual inspection to see if the metal parts of the oil filter appear rusty or if there is a deposit of rusty sludge at the bottom of the oil filter canister, both of which are indications that water is present in the heating oil and that further investigation is needed.

An alternative method of checking for water in the storage tank is by using a water finding paste. This method involves coating the bottom few inches of a probe with water finding paste and lowering the probe to the bottom of the storage tank. The probe may be a rigid stick or a flexible tape; a flexible tape may be required to be used when there is insufficient overhead space to insert a rigid stick long enough to reach the bottom of the storage tank. When the probe is placed into the storage tank the water finding paste changes colour on contact with water and thereby provide a visual indication if there is water present in the storage tank when the probe is removed. However, this method may be an awkward task to perform by the average consumer due to lack of appropriate tools, equipment and location of the storage tank.

Another known problem with storage tanks supplied for domestic heating systems is that they are generally provided with a basic gauge, which is often inaccurate, and can result in the domestic heating system running out of heating oil even though the gauge may indicate that the tank is quarter full. If the heating oil runs out, the fuel system will be required to be purged of air before the boiler of the heating system will reignite; this may require the supplier of the heating oil dispatching a person who can both deliver and purge the fuel system, resulting in the consumer being without heating for a period of days. Furthermore, due to the inaccuracy of the gauge there is also no easy means for the consumer to check that the correct amount of fuel has been delivered.

In addition, over the past years, theft of hydrocarbon products from storage tanks has become a major problem. The high monetary value of hydrocarbon products, combined with the fact that there is little to no protection available to deter or stop the theft of the contents from above ground storage tanks, has lead to the number of reported incidents of heating oil theft during the period from 2006 to 2008 increasing by 264%.

It is an object of the present invention to overcome or at least mitigate one or more of the aforementioned problems.

### SUMMARY OF THE INVENTION

In accordance with an aspect of the present invention, there is provided a storage tank monitoring apparatus comprising;

a measurement device for determining a level of a stored substance within in a storage tank, said measurement device being arranged to detect the presence of a second substance in the storage tank; and

a processor arranged to generate a signal if the second substance is detected in the storage tank.

The apparatus of the present invention provides the advantage of having a measurement device that can be used to automatically detect the presence of a second substance in a storage tank. This apparatus therefore reduces the chance of a second unwanted substance accumulating in a storage tank and eliminates the need for routine manual checking, which may be forgotten or just not be performed.

In addition, the apparatus of the present invention includes a measurement device providing an indication of the level of the stored substance in the storage tank; this enables a consumer to reliably determine when to reorder the stored substance and so prevent the stored substance from running out completely. Furthermore, the apparatus provides a more accurate means of verifying delivered loads when the storage tank is filled or topped-up.

Preferably, the measurement device includes a portion arranged to be located at a lower portion of a storage tank to detect the presence of the second substance.

In a preferred embodiment of the present invention at least a part of the measurement device is coated with a compound that changes a property when the compound comes into contact with the second substance. Such a compound is easy to apply and provides the advantage of making the apparatus more sensitive to the detection of the second substance in the storage tank.

The property of the compound that changes may be a dielectric constant of the compound.

In one embodiment of the present invention the stored substance may be a hydrocarbon. The hydrocarbon may be, for example, heating oil, diesel, kerosene or the like.

In a preferred embodiment of the present invention the second substance is water. Preferably, the compound is a water finding paste. Water finding paste has been found to have the unexpected effects of making the apparatus more sensitive to detecting the presence of water. It is believed that this is due to the change in dielectric constant of the compound when the compound reacts with water, and that the compound is somewhat hydrophilic and can therefore detect the presence of water even though the compound is coated in oil.

The processor may be arranged to indicate that the second substance is detected when a set predefined threshold indicative of a maximum working capacity of the storage tank is reached or exceeded.

In a preferred embodiment of the present invention, the measurement device is adapted to determine a level of a stored substance within a storage tank at a first instant in time and at a second instant in time, and is arranged to provide a signal indicative of the level of the stored substance which is dependent on the measured conductivity within said tank at the first and second instants in time; and the processor is arranged to calculate a rate of change of the level of the stored substance between the first and second instant in time, and indicate if the rate of change of the level of the stored substance exceeds a set predetermined threshold.

Providing a device that calculates the rate of change of the stored substance enables the apparatus to be used to indicate the possibility of a leak in the storage tank or theft of the stored substance from the storage tank.

The predetermined threshold may be representative of leakage of the substance from the storage tank. The predetermined threshold may be set at about 1 liters/minute. Therefore, the apparatus can be arranged to detect a leak of the stored substance which may be costly to the consumer as well as damaging to the environment.

The predetermined threshold may be representative of theft of the substance from the storage tank. The predetermined threshold may be set at about 5 liters/minute. Therefore, the apparatus can be arranged to detect theft and act as an alarm or a deterrent.

In one embodiment of the present invention, the processor is arranged to generate a further indication when a predefined threshold level is exceeded.

The predefined threshold may be representative of the substance reaching a low limit in the storage tank. The predefined threshold may be set at about 20% of the total capacity of the storage tank. A low level indicator enables the consumer to be notified of the diminishing level of the stored substance and prompt the consumer to take the necessary action to have the storage tanks refilled.

Alternatively or additionally, a predefined threshold may be representative of the substance reaching an upper limit in the storage tank. The predefined threshold may be set at about 90% of the total capacity of the storage tank.

Preferably, the apparatus further comprises a user interface comprising audio and/or visual indicators representative of the level of the stored substance in the tank, leakage from the storage tank, theft from the storage tank, a high level, a low level and the presence of the second substance, or any combination thereof.

Further features and advantages of the invention will become apparent from the following description of a preferred embodiment of the invention, given by way of example only, which is made with reference to the accompanying drawings.

### BRIEF DESCRIPTION OF THE DRAWINGS

FIG. 1 shows a cross-sectional side view of a storage tank with a storage tank monitoring apparatus in accordance with an embodiment of the present invention; and

FIG. 2 shows a flow diagram giving an overview of the method of operation of the apparatus of the present invention.

### DETAILED DESCRIPTION OF THE INVENTION

The present invention relates to a storage tank monitoring apparatus for detecting the presence of a second substance in a storage tank. In the embodiments of the present invention disclosed hereinbelow the storage tank monitoring apparatus has a measurement device that is adapted to measure the level of a, primary, stored substance in the storage tank, and produce a signal on detecting the presence of a second, unwanted, substance in the storage tank.

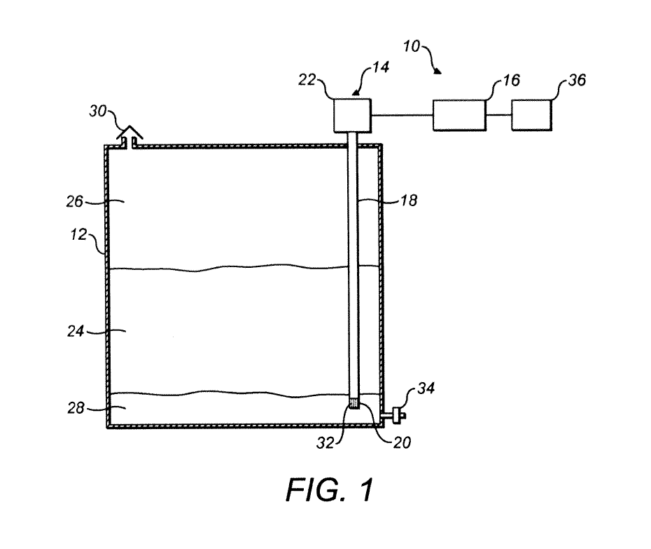

Referring to FIG. 1, there is shown a storage tank monitoring apparatus 10, in accordance with an embodiment of the present invention, which is fitted to a storage tank 12. The storage tank apparatus 10 comprises a measurement device 14 and a processor 16. The measurement device 14 has a single probe 18 which extends vertically from a top of the storage tank 12 and has a free end 20 located in a lower portion of the storage tank 12, i.e. close to a base of the storage tank 12. The measuring device 14 also includes a head unit 22 located at an opposite end to free end 20 of the probe 18.

In use, the measurement device 14 is arranged to measure the total capacitance of the contents of the storage tank 12, with the head unit 22 arranged to convert the total capacitance measurement into a signal, which may for example be a voltage, a resistance or a pulse width modulated signal. The signal produced by the head unit 22 is transmitted to the processor 16 and is representative of the level of a stored substance 24 in the storage tank 12.

The measurement device 14 is used to determine the level of the stored substance 24 in the storage tank 12 by measuring the combined capacitance of the stored substance 24 and air 26 in the storage tank 12. The combined capacitance is measured, for example, by means of two parallel plates located along the longitudinal axis of the probe 18. As the stored substance 24 rises and falls in the storage tank 12 the total capacitance changes and is measured by a control system located in the head unit 22. The change in the total capacitance is dependent on the dielectric constant of the stored substance 24, which if for example is heating oil has a dielectric constant of about 2.0 to 4.0, and the air 26, which has a dielectric constant of 1.0. The capacitance can be determined by the equation:

Capacitance=dielectric constant×(area of plates covered/distance between plates) (1)

Referring to equation (1) the dielectric constant of the stored substance 24, the dielectric constant of the air 26 and the distance between the plates are each constant. Therefore, the only variable on the right hand side of the equation is the area of the plates covered. As the capacitance of the air 26 is considerably smaller than that of, for example heating oil, the total change in capacitance is approximately proportional to the rise or fall of the level of the heating oil in the storage tank 12. Therefore, the level of the heating oil can be determined by the change in capacitance in the storage tank 12.

The storage tank monitoring apparatus 10 is also arranged to detect the presence of a second substance 28, for example water, in the storage tank 12. Water can enter the storage tank 12 in the form of water vapour through a vent 30. When the water vapour comes into contact with the cooler tank interior of the storage tank 12, the water condenses out of vapour to form water droplets on the interior surface of the storage tank 12; over time, this water will accumulate at the base of the storage tank 12, as the water is denser than the heating oil, to form a layer of water.

Detection of water in the storage tank 12 can be determined by the measurement device 14 because the dielectric constant of water is 70, which is approximately 20 to 35 times greater than that of the heating oil. Therefore, as water builds up from the base of the storage tank 12 and comes into contact with the free end 20 of the probe 18, it will create a sudden and dramatic increase in the measured capacitance.

To assist with the detection of the second substance 28 the probe 18 is coated at its free end 20 with approximately a 1 cm to 2 cm wide band of a compound 32 that changes properties when it comes into contact with the second substance 28. Where the second substance 28 is water it has been found that the use of a water finding paste is advantageous because on coming into contact with water the dielectric constant of the water finding paste appears to become approximately 65 times greater than that of oil. The use of a water finding paste manufactured by Ko lor Kut™, the active compound of which is an enzyme based plant extract, has the advantage of having a lower freezing point than other water finding pastes and can therefore be used reliably all year round in temperate climates. Kolor Kut is manufactured by Kolor Kut Products Co. located at 7915 E Elm St, Houston, Tex. 77012, USA. Use of other water finding pastes is envisaged in other embodiments of the invention, for performing a similar function of that described herein. Once applied the compound 32 does not have to be replaced until it reacts with water as the compound does not degrade over time. However, it is suggested that that the compound 32 is replaced as part of an annual inspection.

When the build up of the second substance 28 reaches a level sufficient to make contact with the compound 32, the reaction between the compound 32 and the second substance 28 results in a sudden increase of the measured capacitance by the measurement device 14. The increase in capacitance produces a signal having a maximum output which is indicative of a total level of stored substance in the tank, or capacity of the storage tank greater than a predefined operating range. The signal that is transmitted to the processor 16 is compared with a set predetermined threshold and if the signal is greater than the predetermined threshold the processor 16 generates a signal to indicate the presence of the second substance 28 in the storage tank 12. This indication allows action to be taken before the presence of the second substance 28 causes a problem to the system to which the storage tank 12 is connected.

In one embodiment of the present invention, the predefined operating range has a predefined maximum limit which may be set at 5% below a nominal capacity of the storage tank 12. Storage tanks are provided with a maximum working capacity and a nominal capacity rating, the nominal capacity rating being a working capacity of the storage tank which is greater than the maximum working capacity, but lower than a total storage capacity of the tank. Thus, the nominal capacity can be used to indicate if the maximum working capacity has been exceeded without the tank reaching its total storage capacity and potentially overflowing. Therefore, setting the predefined maximum limit at 5% below the nominal capacity enables the detection of a spike in the capacity reading, which reaches or exceeds the predefined maximum limit that may be caused when water is present in the storage tank 12. In some embodiments the spike may be indicative of the stored substance reaching, or even exceeding, the total storage capacity. In other embodiments of the invention the predefined maximum limit may be set at a different capacity limit of the tank, for example at the nominal capacity or the total storage capacity of the tank, so that the presence of the water in the storage tank causes the spike in the capacity reading to reach, or exceed, the predefined limit.

When a water finding compound is used to assist in the detection of water, when water is detected it is necessary to clean the probe 18 and replace the water finding compound, which has reacted chemically with the water, with a fresh coating of the water finding paste. It is also necessary to remove the layer of water by draining it off, for example, via a tap 34 that may be provided on the storage tank 12, or by requesting the supplier of the heating oil to remove the water.

In one embodiment of the present invention, the storage tank monitoring apparatus 10 is adapted to measure a rate of change of level of the stored substance 24. The measurement device 14 is used to determine the level of the stored substance 24 at a first instant in time and a second instant in time, which may, for example, be 4 seconds apart. The level information at the first and second instants in time is transmitted to the processor 16 which calculates the rate of change of the stored substance 24. If the rate of change of the stored substance 24 exceeds a set predetermined threshold then the processor 16 produces a signal which is indicative that the predetermined threshold has been exceeded. The threshold level may be set to indicate that there is a possible leak, and/or set to indicate theft of the stored substance 24 from the storage tank 12.

Where the storage tank 12 is used for storing domestic heating oil, it is known that the consumption rate of heating oil is about 0.75 litres/minute. Therefore, a threshold may be set at about 1 litre/minute to indicate that the storage tank 12 may be leaking. It is known that heating oil can be siphoned through a/4 inch (about 1.25 centimetres) hose at around 5 litres/minutes or pumped out of the storage tank 12 at around 35 to 40 litres/minute. Therefore a second predetermined threshold limit may be set at around 5 litres/minute to generate an alarm signal to indicate the possible theft of oil from the storage tank 12.

If the rate of change of the stored substance 24 is determined to be indicative of a leak then a visual indication can be displayed on a user interface 36. However, if the change of rate is determined to represent theft of the stored substance 24 then and an audio signal may be generated. Alternatively or additionally, the processor 16 may include a cellular radio network interface that can either send a text message to notify the owner of the possibility of the theft or the cellular radio network interface may be arranged to notify the police of the possible theft and location.

The storage tank monitoring apparatus 10 may include a low level limit indicator, which can be used to indicate that the level of the substance 24 in the storage tank 12 has reached, for example, 20% of the capacity of the tank and prompt refilling of the storage tank 12. The low level limit may notify a supplier through the cellular radio network interface who can then confirm an order with the customer. The storage tank apparatus 10 may include a high level limit indicator to prevent overfilling and spillage of the substance when the storage tanked 12 is being filled.

In use, the storage tank monitoring apparatus 10 can be easily installed by a layman. The first step in setting up the storage tank monitoring apparatus 10 is to calibrate the measurement device 14, which may for example be a T/LL140 series liquid level sensor produced by Fozmula Ltd. Before calibration of the measurement device 14 is undertaken a 1 to 2 cm coating of a water finding paste 32 is placed on the free end 20 of the probe 18. The measurement device 14 is then calibrated by fitting the measurement device 14 to the storage tank 12 so that at least a portion of the probe 18 is immersed in the stored substance 24; the measurement device 14 is then powered up. The measurement device 14 is then powered down and removed from the storage tank 12. On removal of the measurement device 14 from the storage tank 12, the coating of the water finding paste 32 is visually inspected to ensure that there is no water 28 present at the bottom of the storage tank 12. This will be evident as the water finding past 32 would have changed colour, for example from a golden brown to a brilliant red. If water is found in the storage tank 12 this needs to be removed as discussed hereinabove. The measurement device 14 is then powered up in free air and once again fitted to the storage tank 12 whilst still powered up. The measurement device 14 is now calibrated and the user interface 36 should indicate the level of the stored oil 24 in the storage tank 12. The installation of the storage tank monitoring apparatus is now completed.

Once the measurement device 14 has been calibrated the probe 18 may be removed, whenever required from the storage tank 12 and for any period of time, without the need for the measurement device having to be recalibrated.

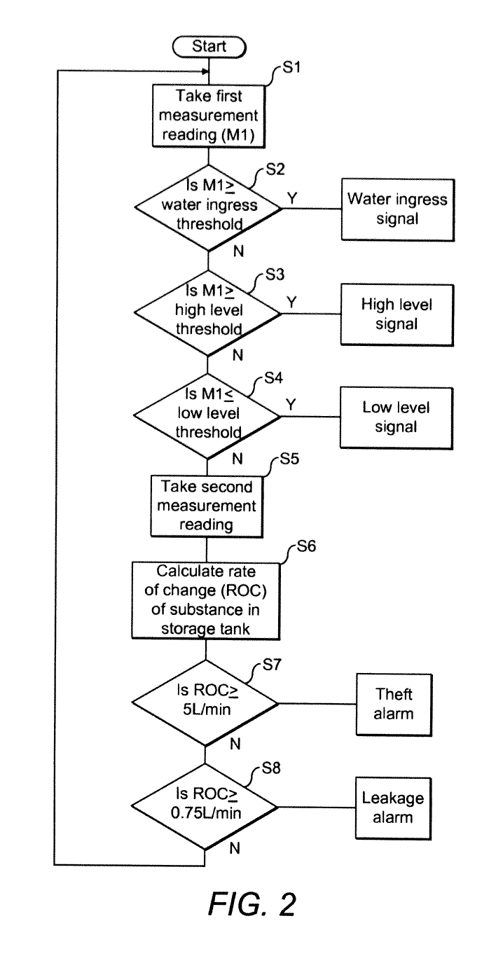

Referring to FIG. 2, the operation of the storage tank monitoring apparatus 10 is shown in accordance with an embodiment of the present invention. At step S1, the storage monitoring apparatus 10 obtains a first measurement of the level of the stored substance 24 in the storage tank 12 at a first instant in time. The first measurement is then compared with a set predetermined threshold to see if the water ingress threshold has been reached at step S2. The water ingress threshold may be set, for example at 110% of the maximum predefined operating limit of the storage tank 12. If the water ingress threshold has been reached then a water ingress signal is generated. If the water ingress threshold level is not reached then the operation proceeds to step S3.

At step S3, the first measurement is compared with a set predefined threshold to see if a high level limit threshold has been reached. If the high level limit threshold has been exceeded then a high level signal is generated. If the high level limit level has not been exceeded then the operation proceeds to step S4.

At step S4, the first measurement is compared with a set predefined threshold to see if a low level limit threshold has been reached. If the low level limit threshold has been reached then a low level signal is generated. If the low level limit level has not been exceeded then the operation proceeds to step S5.

At step S5, the storage monitoring apparatus 10 obtains a second measurement of the level of the stored substance 24 in the storage tank 12 at a second instant in time. The first and second measurements are then processed to calculate the rate of change of the stored substance 24 in the storage tank 12 at step S6.

The rate of change is then compared to a set predetermined threshold to see if the rate of change is representative of theft of the stored substance 24 at step S7. The rate of change can be set at about 5 litres/minute. If the rate of change is representative of theft then an alarm is generated. If the rate of change is not representative of theft then the operation proceeds to step S8.

At step S8, the rate of change is compared to a set predetermined threshold to see if the rate of change is representative of a leak of the stored substance 24. The rate of change can be set at about 1 litres/minute. If the rate of change is representative of a leak then a leak signal is generated. If the rate of change is not representative of a leak then the operation proceeds to loop back to step S1.

The above embodiments are to be understood as illustrative examples of the invention. Further embodiments of the invention are envisaged. For example, the signal transmitted from the head-unit 22 may be connected directly to a gauge or meter, which has been adapted to indicate a level of the substance or if a level of a second substance is located within the storage tank.

The storage tank monitoring apparatus may include a high level signal, low level signal, leak signal, theft signal or any combination thereof. The signal generated may be used to activate a visual indictor and/or an audio alarm. The compound 32 may be located at an upper level of the probe 18 if the second substance 28 to be detected has a density less than that of the stored substance 24.

The maximum operating limit and the high level limit may be set at the same value. The steps performed in the operation of the storage tank monitoring apparatus, as illustrated in FIG. 2, may be reordered in any suitable manner to perform the function(s) that the storage tank monitoring apparatus has been adapted to perform.

The storage tank monitoring apparatus may be arranged to collect and analyse data to determine the energy consumption of a system or device connected to the storage tank and thereby measure the carbon footprint.

It is to be understood that any feature described in relation to any one embodiment may be used alone, or in combination with other features described, and may also be used in combination with one or more features of any other of the embodiments, or any combination of any other of the embodiments.

Furthermore, equivalents and modifications not described above may also be employed without departing from the scope of the invention, which is defined in the accompanying claims.

1. A storage tank monitoring apparatus comprising; a measurement device for determining a level of a stored substance in a storage tank, said measurement device being arranged to detect the presence of a second substance in the storage tank; and a processor arranged to generate a signal if the second substance is detected in the storage tank.

2. An apparatus according to claim 1, wherein the measurement device includes a portion arranged to be located at a lower portion of a storage tank to detect the presence of the second substance.

3. An apparatus according to claim 1, wherein at least a part of the measurement device is coated with a compound that changes a property when the compound comes into contact with the second substance.

4. An apparatus according to claim 3, wherein the property is a dielectric constant of the compound.

5. An apparatus according to claim 1, wherein the stored substance is a hydrocarbon.

6. An apparatus according to claim 1, wherein the second substance is water.

7. An apparatus according to claim 3, wherein the compound is a water finding paste.

8. An apparatus according to claim 1, wherein the measurement device is arranged to provide a signal indicative of the level of the stored substance within the storage tank at a first and a second instant in time; and the processor is arranged to calculate a rate of change of the level of the stored substance between the first and second instant in time, and indicate if the rate of change of the level of the stored substance exceeds a set predetermined threshold.

9. An apparatus according to claim 8, wherein the predetermined threshold is representative of leakage of the substance from the storage tank.

10. An apparatus according to claim 9, wherein the predetermined threshold is set at about 1 liters/minute.

11. An apparatus according to claim 8, wherein the predetermined threshold is representative of theft of the substance from the storage tank.

12. An apparatus according to claim 11, wherein the predetermined threshold is set at about 5 liters/minute.

13. An apparatus according to claim 1, wherein the processor is arranged to indicate that the second substance is detected when a set predefined threshold indicative of a maximum working capacity of the storage tank is reached or exceeded.

14. An apparatus according to claim 13, wherein the processor is arranged to generate a further indication when the predefined threshold is exceeded.

15. An apparatus according to claim 14, wherein the predefined threshold is representative of the substance reaching a low limit in the storage tank.

16. An apparatus according to claim 15, wherein the predefined threshold is set at about 20% of the total capacity of the storage tank.

17. An apparatus according to claim 14, wherein the predefined threshold is representative of the substance reaching an upper limit in the storage tank.

18. An apparatus according to claim 17, wherein the predefined threshold is set at about 90% of the total capacity of the storage tank.

19. An apparatus according to claim 1, wherein the apparatus further comprises a user interface comprising audio and/or visual indicator representative of the level of the stored substance in the tank, leakage from the storage tank, theft from the storage tank, a high level, a low level and the presence of the second substance, or any combination thereof.
